(19) United States
(12) Patent Application Publication
(10) Pub. No.: US 2018/0168183 A1
(43) Pub. Date: Jun. 21, 2018

(54) Food delivery device

(71) Applicant: Janice Jensen, Castell, TX (US)

(72) Inventor: Janice Jensen, Castell, TX (US)

(21) Appl. No.: 15/383,295

(22) Filed: Dec. 19, 2016

(51) Int. Cl. A23G 3/56

(52) U.S. Cl. CPC A23G 3/563

(57) ABSTRACT

A food delivery device for delivering food may include a food portion being edible; and a support device to support the food portion. The support device may be shaped as a cylinder. The food portion may be formed entirely from vegetables.

### FIELD OF THE INVENTION

The present invention relates to a food delivery device and more particularly to a food delivery device including a cork in the shape of a cylinder.

### BACKGROUND

It is known, more particularly by the French patent 2 383 611, to obtain a sparkling confectionery with two components, including as the principal component chewing gum having a moisture content of 0.10% to 5% in weight and as a second component, gasified sugar having an approximate moisture content of 1 to 5% in weight. These two components are having about the same percentage of water between 0.10% to 0.30%. This confectionery is original since it sparkles in the mouth of the user by a progressive release of the gas previously confined in the sugar, upon dissolution of it by the saliva.

It is also known by the French patent 2 457 074, to fabricate sparkling candies by adding gas directly, generally carbonic gas or air, in the sugary mass constituting the candy by using the manufacturing process described in this patent.

On the other hand, the French patent 2 610 481, discloses a gasified process of a mass of melted sugar intended to be marketed as gasified sugar. This sugar has been fragmented with a granulometry compatible with their subsequent use in diverse candy preparations in the industry of confectionery, in the areas where this sparkling form is sought.

### SUMMARY

A food delivery device for delivering food may include a food portion being edible; and a support device to support the food portion.

The support device may be shaped as a cylinder.

The food portion may be formed entirely from vegetables.

The food portion may be formed entirely from candy.

The food portion may be formed entirely from pasta.

The food portion may be formed entirely from chocolate.

The support device may be formed from cork material.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the food delivery device of the present invention;

FIG. 2 illustrates a cross-sectional view of the food portion of the food delivery device of the present invention;

FIG. 3 illustrates a bottom view of the food portion of the food delivery device of the present invention;

FIG. 4 illustrates a top view of the food portion of the food delivery device of the present invention;

FIG. 5 illustrates a cross-sectional view of the food delivery device;

FIG. 6 illustrates a top view of the support device of the food delivery device;

FIG. 7 illustrates an embodiment of the food portion of the food delivery device;

FIG. 8 illustrates another embodiment of the food portion of the food delivery device;

FIG. 9 illustrates another embodiment of the food portion of the food delivery device of the present invention;

FIG. 10 illustrates a bottom view of the support device of the food delivery device of the present invention;

FIG. 11 illustrates a side view of the support device of the food delivery device of the present invention.

### DETAILED DESCRIPTION

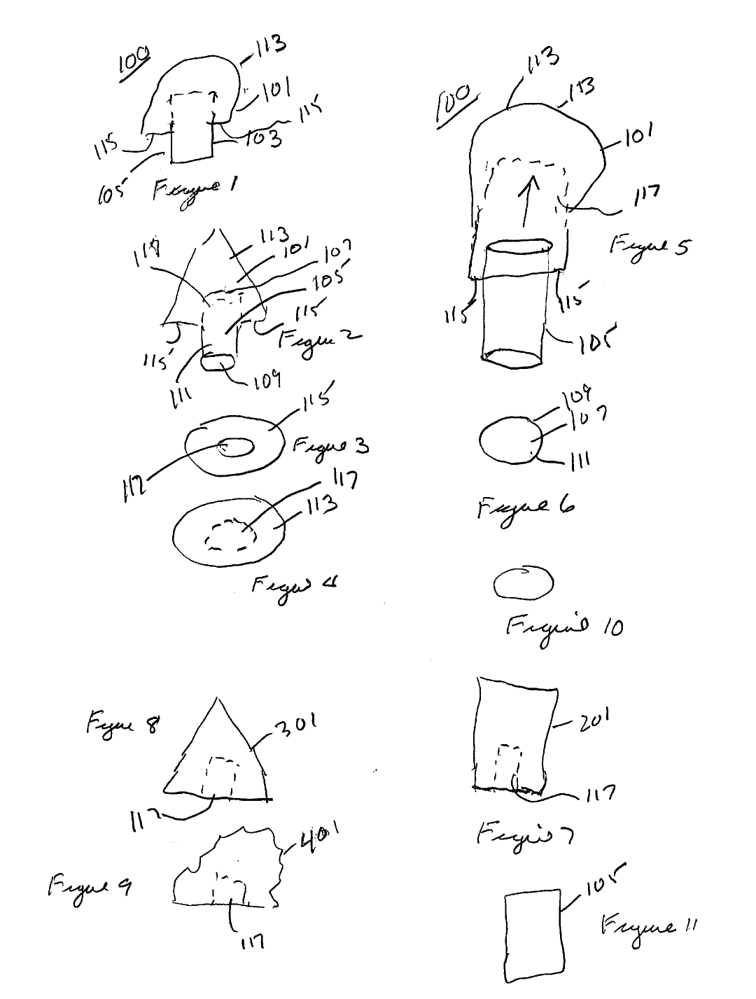

FIG. 1 illustrates a cross-sectional view of the food delivery device 100 of the present invention, and FIG. 1 illustrates that the food delivery device 100 may include a food portion 101 and a support portion 103 which may include a support device 105 which may be a bottle stopper which may be a cork. The support device 105 may be in the shape of a cylinder having a top surface 107, a bottom surface 109 being opposed to the top surface 107 and a peripheral side surface 111 which may connect the top surface 107 with the bottom surface 109. The support device 105 may be formed from actual cork, plastic, metal, wood or other combination or other appropriate material and may be solid, hollow or any other design. The food portion 105 may be formed from an edible material including vegetables, candy, pasta, chocolate or any other appropriate material. The food portion 101 may include an outer surface 113 which may be configured to cover the support device 105 and which may include a shoulder 115 which may extend around the support device 105. The shoulder 115 may extend to an aperture 117 which may cooperate with the support device 105.

FIG. 2 illustrates a cross-sectional view of the food portion 101 and the support device 105. The food portion 101 may include an outer surface 113 which may be configured to cover the support device 105 and which may include a shoulder 115 which may extend around the support device 105. The shoulder 115 may extend to an aperture 117 which may cooperate with the support device 105.

The support device 105 may be in the shape of a cylinder having a top surface 107, a bottom surface 109 being opposed to the top surface 107 and a peripheral side surface 111 which may connect the top surface 107 with the bottom surface 109.

FIG. 3 illustrates a bottom view of the food portion 101 of the food delivery device of the present invention.

FIG. 3 illustrates the shoulder 115 and the aperture 117.

FIG. 4 illustrates a top view of the food portion 101 of the food delivery device of the present invention.

FIG. 4 illustrates the outer surface 113 and the aperture 117.

FIG. 5 illustrates a cross-sectional view of the food delivery device 100.

FIG. 5 illustrates the food portion 101 which may include the outer surface 113 the shoulder 115 and the aperture 117 and the support device 105 having the top surface 107, the bottom surface 109 which may be opposed to the top surface 107 and the peripheral side surface 111 which may connect the top surface 107 to the bottom surface 109.

FIG. 6 illustrates a top view of the support device 105 of the food delivery device showing the top surface 107, the bottom surface 109 which may be opposed to the top surface 107 and the peripheral side surface 111 which may connect the top surface 107 to the bottom surface.

FIG. 7 illustrates an embodiment of the food portion 201 of the food delivery device, and the food portion 201 may be substantially cylinder shaped. The aperture 117 is additionally shown.

FIG. 8 illustrates another embodiment of the food portion 301 of the food delivery device where the food portion 301 may be dome shaped. The aperture 117 is additionally shown.

FIG. 9 illustrates another embodiment of the food portion 401 of the food delivery device of the present invention where the food portion 401 is offset from center. FIG. 9 additionally illustrates the aperture 117.

FIG. 10 illustrates a bottom view of the support device 105 of the food delivery device 100 of the present invention;

FIG. 11 illustrates a side view of the support device 105 of the food delivery device of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A food delivery device for delivering food, comprising:
a food portion being edible;
a support device to support the food portion;
wherein the support device is shaped as a cylinder.

2) A food delivery device for delivering food as in claim 1, wherein the food portion is formed entirely from vegetables.

3) A food delivery device for delivering food as in claim 1, wherein the food portion is formed entirely from candy.

4) A food delivery device for delivering food as in claim 1, wherein the food portion is formed entirely from pasta.

5) A food delivery device for delivering food as in claim 1, wherein the food portion is formed entirely from chocolate.

6) A food delivery device for delivering food as in claim 1, wherein the support device is formed from cork material.
